(19) United States
(12) Patent Application Publication
(10) Pub. No.: US 2007/0194501 A1
(43) Pub. Date: Aug. 23, 2007

(54) Blown film extrusion system

(76) Inventors: Jurgen Linkies, Lienen (DE); Thomas Knoke, Bielefeld (DE); Martin Backmann, Lengerich (DE); Holger Frische, Hasbergen (DE)

Correspondence Address: JACOBSON HOLMAN PLLC, 400 SEVENTH STREET N.W., SUITE 600, WASHINGTON, DC, 20004, US

(21) Appl. No.: 10/591,836

(22) PCT Filed: Feb. 22, 2005
(86) PCT No.: PCT/EP05/01923

§ 371 Date: Sep. 5, 2006

(30) Foreign Application Priority Data
Mar. 4, 2004 (DE) 10 2004 011 216.9
Mar. 25, 2004 (DE) 10 204 031 366.0

(51) Int. Cl. B29C 57/00; B29C 47/00

(52) U.S. Cl. 264/563; 425/532

(57) ABSTRACT

The invention describes a blown film extrusion system (1), which comprises, as its characteristics, a blowing head (5), which extrudes a film tube (9), further a pinch-off device (8), which pinches off the film tube (9), and additionally film guiding elements (7, 13, 27, 28) that guide the film tube (9) between its extrusion by the blowing head and its pinching off.

The inventive aspect is that the guiding elements (7, 13, 27, 28) contain a porous, preferably microporous material.

The invention relates to a blown film extrusion system according to the preamble of claim 1.

Such blown film extrusion systems are known and are already in use for a long time. Such systems are supplied with plastics in a granulated form, which are then plasticized to a viscous mass in extruders under a high effect of pressure. This mass, which has a high temperature due to the pressure, is formed circularly in a blowing head and is discharged from the blowing head through a tubular die. The mass already forms a film tube immediately after leaving the tubular die. However, the diameter of this film tube can change since the film tube is not yet cooled down completely. Usually, the diameter is increased by blowing in compressed air into the interior of the film tube. The film tube is guided at a distance from or directly along film guiding elements so that said film tube has a constant diameter at all times. This arrangement of the film guiding elements is referred to as calibrations cage in the field of blown film extrusion systems. After passing through the calibrations cage, the film tube, which has now solidified, is guided along additional film guiding elements, which lay the tube flat. This lay flat unit supplies the film tube to a pinch-off device so that said film tube forms a two-ply film web. The term “pinching off” is meant to connote the process of laying the film tube completely flat as well as non-completely. The process of laying the film tube flat in a non-complete form can be followed by further processing steps, such as, for example, longitudinal cutting along the folded edges.

The film guiding elements can be interspersed with bores, which are supplied with compressed air on the side turned away from the film tube. The compressed air flowing through the bores, which have a diameter of, for example, 0.5 mm, keeps the film tube at a distance so that the latter is guided contactlessly. In this way the film tube is also prevented from getting damaged.

However, the bores must have a certain distance from one another so that the film guiding elements do not lose their stability. However, as a result, the air cushion guiding the film tube does not act evenly on the circumference of the film tube. This interferes with the guiding accuracy. The result is larger inaccuracies in the diameter of the film tube. The film tube also tends to flutter due to the uneven application of the compressed air.

It is therefore the object of the present invention to suggest a blown film extrusion system, in which the guiding accuracy is increased in the area of the film guiding elements.

Said object is achieved by the characterizing features of claim 1.

Thus the guiding elements contain a porous, preferably a microporous material. The material thus has a plurality of continuous pores. Therefore the film guiding elements can be supplied with compressed air on the side turned away from the film tube. The compressed air then forms an almost even air cushion on the side turned towards the film tube. The quality of guidance of the film tube can be increased with the help of this air cushion. As a result, the diameter of the film tube has lower tolerances. Furthermore, the evened-out air cushion causes an additional cooling of the film so that the latter can be cooled faster. This is manifested in a greater transparency of the film. On the whole, the use of such guiding elements can increase the quality of the film considerably.

Preferably, sintered material is used as the material having these properties. Sintered material can be produced easily, since subsequent mechanical processing can be omitted.

In a preferred embodiment, the porous material has metallic components such as, for example, copper or bronze. This leads to a high stability of the material so that the film guiding elements can be kept relatively thin.

In an advantageous embodiment of the blown film extrusion system according to the invention, the porous material is arranged in such a way between the route of transport of the film tube and a compressed air reservoir or a compressed air supply line that air escapes through the material thereby exerting a force on the film. The material can be shaped as plates or sheets, the surfaces of which are arranged parallel or substantially tangentially to the film tube. Furthermore, the plates or sheets can be bent easily. The thickness of the plates is between 1 and 10 mm, preferably between 2 and 5 mm. The average pore size of the porous material is between 5 and 100, particularly between 10 and 60 and preferably between 20 and 45 micrometers.

In another advantageous design form of a blown film extrusion system according to the invention, the porous material is arranged in the region of the calibrations cage, several isolated surfaces made of porous material being turned towards the film tube. The entirety of these isolated surfaces delimit the outer covering of a cylinder, the diameter of which can be changed. In this way film tubes of high quality can be produced even with variable diameters. Advantageously, at least one part of the surfaces is staggered with respect to the others in the circumferential direction of the film tube.

Additional advantageous design forms of the invention are specified in the dependent claims and the drawings. The individual figures show:

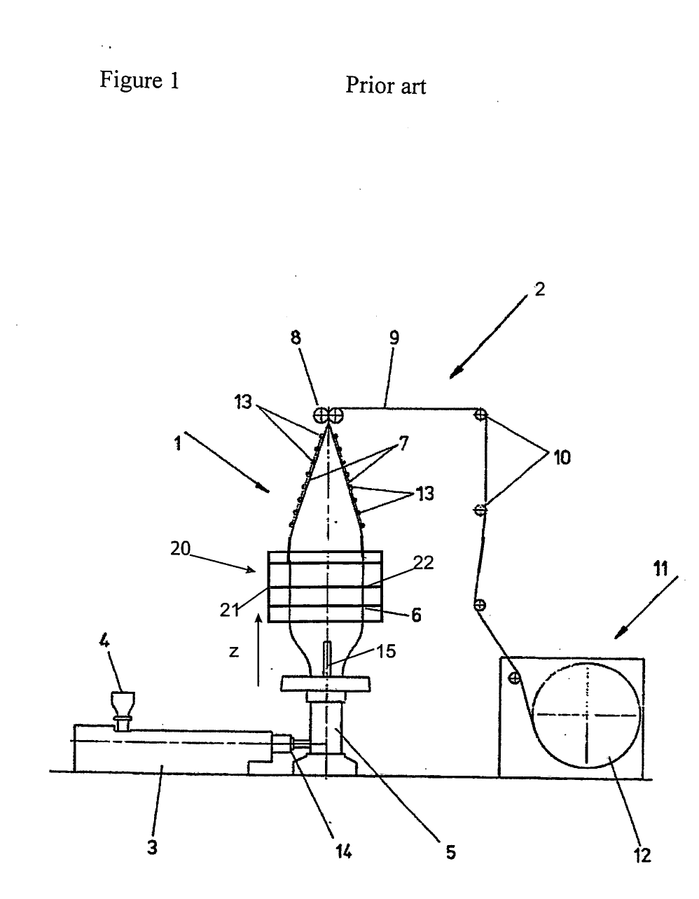

FIG. 1 a blown film extrusion system according to the prior art

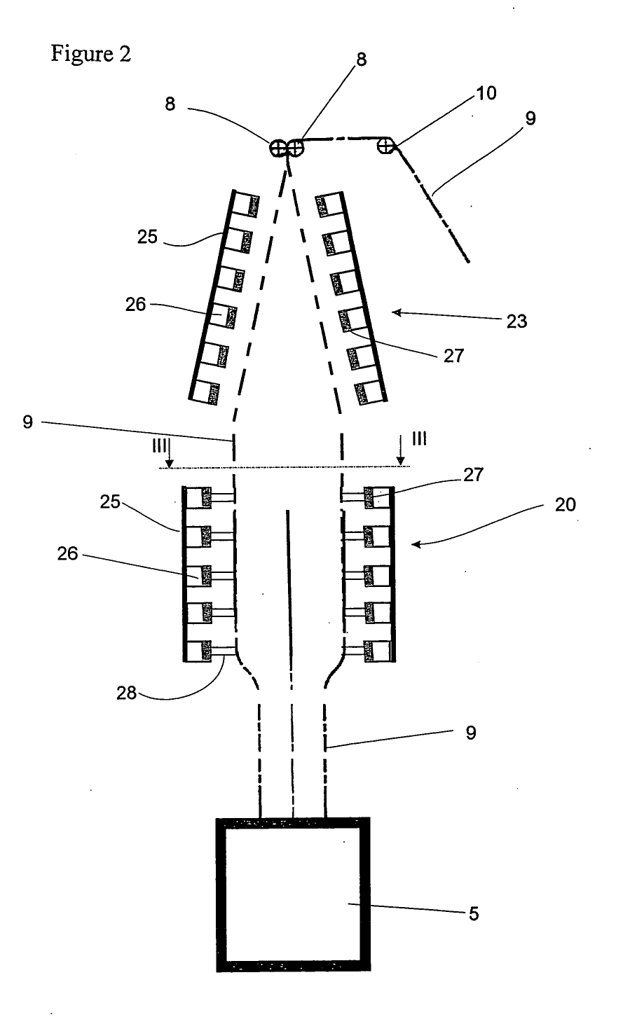

FIG. 2 a blowing head, calibrations cage and lay flat unit of a blown extrusion system according to the invention

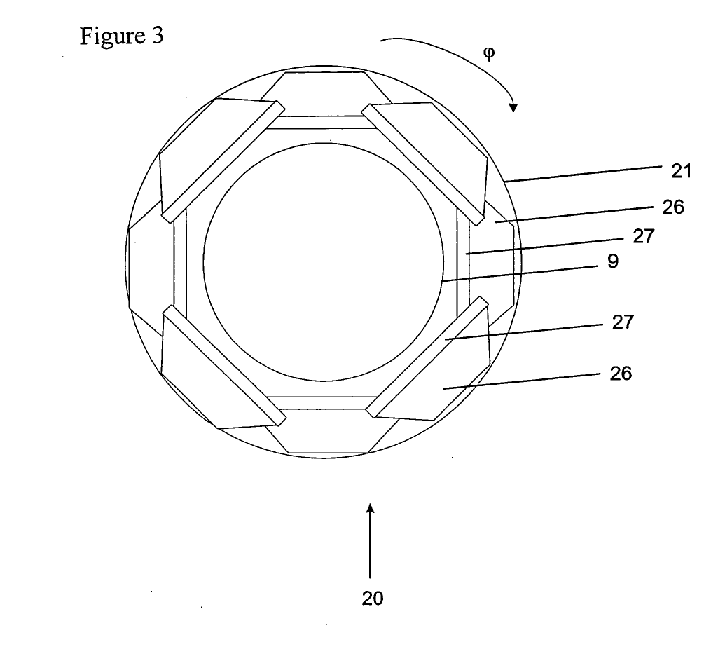

FIG. 3 view III-III shown in FIG. 2.

FIG. 1 shows a known blown film extrusion system 1. The filling piece 4 is supplied with a plastic, which is then plasticized in the extruder 3. The resulting mass is supplied using a connecting line 14 to the blowing head 5 and forms a film tube 9. In doing so, the film tube 9 leaves the blowing head 5 through a tubular die (not illustrated) in the transfer direction z. Due to the supply of compressed air through the blower 12 [sic: 15], the film tube is expanded immediately after leaving the blowing head 5. However, the diameter of the film tube 9 is delimited by the calibrations cage 20. Inside the calibrations cage 20, the film tube 9 is guided by plates 28, through which compressed air is directed towards the film tube. The calibrations cage 20 further consists of a frame 21 and cross beams 22 and 6. After leaving the calibrations cage 20, the film tube 9 arrives into a lay flat unit 21 in which the film tube is almost or completely transformed into a two-ply film web. The film tube 9 is guided between pairs of guiding elements 7, 13, which assume a constantly reducing distance from one another in the course of the transfer direction z. The process of laying the film tube completely flat takes place using a pinch-off device, which consists of a pair of pinch rollers 8. The film web 9 can now be guided by an oscillating unit (not illustrated) or the film web can be supplied to a winding device 11 directly using deflecting rollers 10 as in the case of the device illustrated. The film web 9 is processed to a roll 12 on the winding device 1 1.

FIGS. 2 and 3 show sections of a blown film extrusion system 1 according to the invention. Several compressed air reservoirs 26 are arranged on a frame 25 in the region of the calibrations cage 20. Several compressed air reservoirs 26 are arranged above one another in the course of the transfer direction z. Similar compressed air reservoirs 26 are fixed in the frame 25 of the lay flat unit 21. However, it must be pointed out that either the calibrations cage 20 or the lay flat unit 21 can also be designed in the manner known from prior art in a blown film extrusion plant 1 according to the invention. The compressed air reservoirs 26 of the calibrations cage 20 are supported using adjusting drives (not illustrated) such that they can move in the radial direction relative to the film tube and thus define the diameter of the film tube 9. It can be seen in FIG. 3 that the compressed air reservoirs 26 are distributed over the circumference of the calibrations cage, the compressed air reservoirs 26 arranged on the different planes being staggered with respect to one another in the circumferential direction φ of the film tube 9.

The compressed air reservoirs 26 are supplied with compressed air using compressed air lines (not illustrated), the compressed air reservoirs 26 of the lay flat unit 21 being occupied with greater pressure than the compressed air reservoirs of the calibrations cage 20 since the film tube 9 requires the exertion of larger forces for the purpose of deformation. On the side turned towards the film tube 9, the compressed air reservoirs 26 are closed by plates made of porous material 27 through the pores of which, however, compressed air can enter. The plates made of porous material 27 are arranged in such a way that the compressed air exerts a force on the film tube 9 and keeps the latter at a small but well-defined distance from the plates. In this way the film tube 9 is guided with accurate positioning.

List of reference symbols

| | |
|---|---|
| 1 | Blown film extrusion system |
| 2 | |
| 3 | Extruder |
| 4 | Filling piece |
| 5 | Blowing head |
| 6 | Transverse beam |
| 7 | Guiding element |
| 8 | Pinch roller |
| 9 | Film tube |
| 10 | Deflecting roller |
| 11 | Winding device |
| 12 | Roll |
| 13 | Guiding element |
| 14 | Connecting line |
| 15 | Blower |
| 16 | |
| 17 | |
| 18 | |
| 19 | |
| 20 | Calibrations cage |
| 21 | Lay flat unit |
| 22 | Transverse beam |
| 23 | |
| 24 | |
| 25 | Frame |
| 26 | Compressed air reservoir |
| 27 | Plates made of porous material 27 |
| 28 | Plates |
| 29 | |
| 30 | |
| z | Transfer direction of the film tube 9 |
| φ | Circumferential direction of the film tube |

1. Blown film extrusion system (1), which comprises at least the following characteristics:
a blowing head (5), which extrudes a film tube (9),
a pinch-off device (8), which pinches off the film tube (9),
film guiding elements (7, 13, 27, 28) that (3) guide the film tube (9) between its extrusion by the blowing head and its pinching off
said blown film extrusion system being characterized in that the guiding elements (7, 13, 27, 28) contain a porous, preferably microporous material.

2. Blown film extrusion system (1) according to claim 1 characterized in that the porous material is sintered material.

3. Blown film extrusion system (1) according to claim 1 characterized in that the porous material comprises metallic components such as copper or bronze.

4. Blown film extrusion system (1) according to claim 1, characterized in that the porous material is arranged in such a way between the route of transport of the film and/or the film tube (9) and a compressed air reservoir or an air supply line that air escapes through the porous material thereby exerting a force on the film.

5. Blown film extrusion system (1) according to claim 1, characterized in that the porous material has a thickness of between 1 and 10 mm.

6. Blown film extrusion system (1) according to the afore-mentioned claim, characterized in that the porous material has a thickness of between 2 and 5 mm.

7. Blown film extrusion system (1) according to claim 1, characterized in that the porous material has an average pore size of between 5 and 100 micrometers.

8. Blown film extrusion system (1) according to the afore-mentioned claim, characterized in that the porous material has an average pore size of between 10 and 60 micrometers.

9. Blown film extrusion system (1) according to the afore-mentioned claim characterized in that the porous material has an average pore size of between 20 and 45 micrometers.

10. Blown film extrusion system (1) according to the afore-mentioned claim, characterized in that the porous material is arranged in the region of the calibrations cage and/or the pinch-off unit.

11. Blown film extrusion system (1) according to the afore-mentioned claim, characterized in that the porous material is arranged in the region of the calibrations cage (20), several isolated plates made of porous material (27) being turned towards the film tube.

12. Blown film extrusion system (1) according to the afore-mentioned claim, characterized in that at least one part of the plates made of porous material (27), which part is staggered with respect to the other parts in the conveying direction (z) of the film tube (9), is also staggered with respect to the other parts in the circumferential direction (φ) of the film tube (9).

13. Method for operating a blown film extrusion system according to claim 4 characterized in that the pressure in the air reservoir (26) and/or the air supply line is adjusted in such a way that the pressure difference between the air reservoir and/or the air supply line and the ambient air is between 10 millibars and 1 bar.

14. Method for operating a blown film extrusion system (1) according to the afore-mentioned claim characterized in that the pressure in the air reservoir (26) and/or the air supply line is adjusted in such a way that the pressure difference between the air reservoir (26) and/or the air supply line and the ambient air is between 20 and 200 millibars.

15. Method for operating a blown film extrusion system (1) according to the afore-mentioned claim characterized in that the pressure in the air reservoir (26) and/or the air supply line is adjusted in such a way that the pressure difference between the air reservoir (26) and/or the air supply line and the ambient air is between 10 and 100 millibars.

16. Method for operating a blown film extrusion system according to the afore-mentioned claim characterized in that the pressure in the air reservoir (26) and/or the air supply line is adjusted in such a way that the pressure difference between the air reservoir (26) and/or the air supply line and the ambient air is between 30 and 90 millibars.
